(19) United States
(12) Patent Application Publication
(10) Pub. No.: US 2009/0052067 A1
(43) Pub. Date: Feb. 26, 2009

(54) LENS MODULE

(75) Inventors: Chia-Hung Chen, Taipei (TW); Chin-Ching Wang, Taipei (TW)

Correspondence Address: PCE INDUSTRY, INC.;ATT. CHENG-JU CHIANG, 458 E. LAMBERT ROAD, FULLERTON, CA, 92835, US

(73) Assignees: PREMIER IMAGE TECHNOLOGY(China) LTD., Foshan City (CN); HON HAI PRECISION INDUSTRY CO., LTD., Tu-Cheng (TW)

(21) Appl. No.: 12/057,687

(22) Filed: Mar. 28, 2008

(30) Foreign Application Priority Data
Aug. 24, 2007 (CN) 200710201452.6

(51) Int. Cl. G02B 7/04

(52) U.S. Cl. 359/823

(57) ABSTRACT

A lens module includes at least one lens group, a fixed barrel, a rotatable barrel receiving the fixed barrel, a holder, and a number of fasteners. The fixed barrel has the at least one lens group received therein and defines a number of fastener holes oriented parallel with an optical axis of the lens group. The rotatable barrel is rotatable relative to the fixed barrel about the optical axis. The holder defines a plurality of through holes parallel with an optical axis corresponding to the fastener holes of the fixed barrel. The fasteners are configured for securing the fixed barrel to the holder via the through holes and being received in the fastener holes.

### TECHNICAL FIELD

The present invention relates to lens modules, particularly to a lens module of an optical projection device.

### DESCRIPTION OF RELATED ART

A lens module of an optical projection device generally includes a lens holder, a fixed barrel, and a rotatable barrel. In the optical projection device, the lens holder is disposed near a light source of the optical projection device, which generates a great deal of heat during operation. Therefore, the lens holder should be made of thermal deformation resistant material. Typically, lens holders are not integrally molded with the barrels in order to reduce the cost of the lens module.

Generally a lens holder has a tube-shaped portion internally threaded at one end. The fixed barrel is externally threaded at one end for engaging with the internal thread of the lens holder. Both the tube-shaped portion of the lens holder and the fixed barrel further include a number of fastener holes therein. The threaded portions in the lens module are formed by lathes, which costs too much time and money.

What is needed, therefore, is a lens module that can overcome the above-described shortcoming.

### SUMMARY

In accordance with one present embodiment, a lens module includes at least one lens group, a fixed barrel, a rotatable barrel receiving the fixed barrel, a holder, and a number of fasteners. The fixed barrel has the at least one lens group received therein and defines a number of fastener holes oriented parallel with an optical axis of the lens group. The rotatable barrel is rotatable relative to the fixed barrel about the optical axis. The holder defines a plurality of through holes parallel with an optical axis corresponding to the fastener holes of the fixed barrel. The fasteners are configured for securing the fixed barrel to the holder via the through holes and being received in the fastener holes.

Other novel features and advantages will become more apparent from the following detailed description when taken in conjunction with the accompanying drawings.

### BRIEF DESCRIPTION OF THE DRAWINGS

Many aspects of the present lens module can be better understood with reference to the following drawings. The components in the drawing are not necessarily drawn to scale, the emphasis instead being placed upon clearly illustrating the principles of the present lens module.

FIG. 1 is an exploded view of a lens module according to a present embodiment.

FIG. 2 is an exploded view of a fixed portion of the lens module of FIG. 1.

FIG. 3 is schematic assembled view of the fixed portion of FIG. 2.

### DETAILED DESCRIPTION OF THE EMBODIMENTS

Embodiments of the present invention will now be described in detail below, with reference to the drawings.

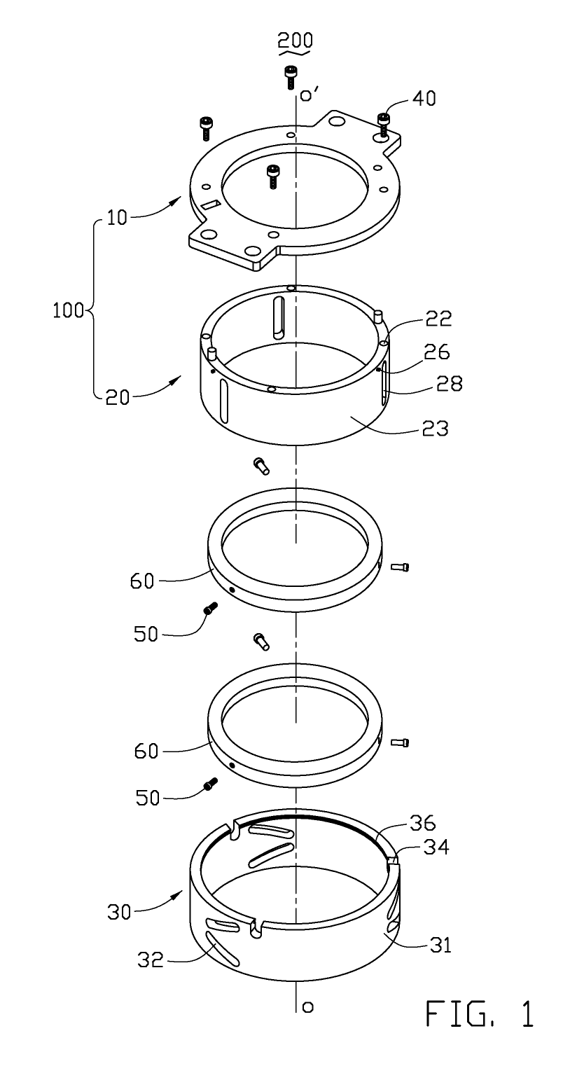

FIG. 1 shows in an exploded view of a lens module 200 according to an embodiment of the invention. In this embodiment, the lens module 200 is adapted for projectors. The lens module 200 includes a holder 10, a fixed barrel 20, a rotatable barrel 30, a number of fasteners 40 such as screws, at least one lens group 60 having an optical axis OO′, and a number of cam followers 50. The holder 10, the fixed barrel 20, and fasteners 40 cooperate to form a fixed portion 100 of the lens module 200.

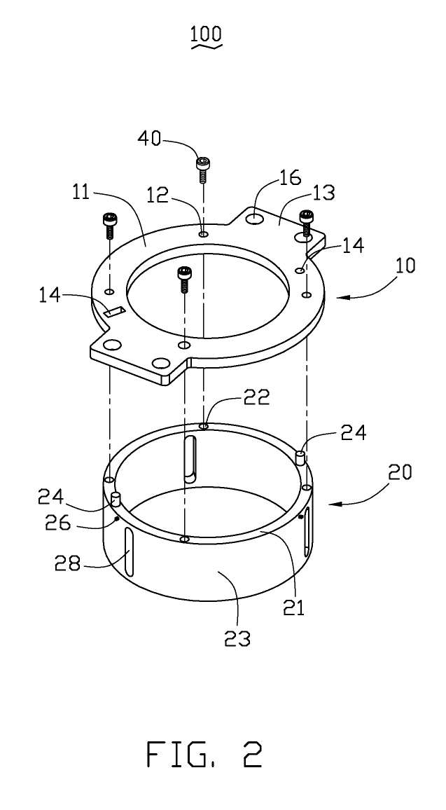

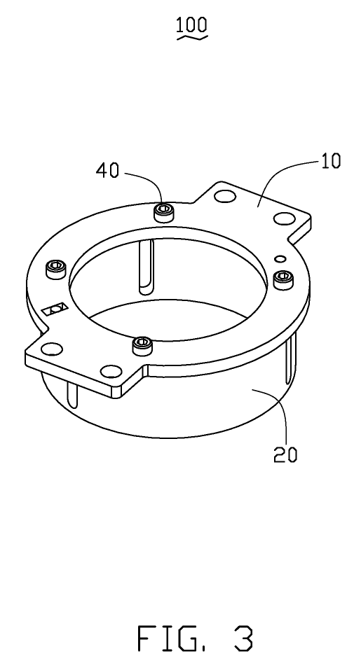

Further referring to FIG. 2 and FIG. 3, the lens holder 10 includes a ring-shaped connecting portion 11 and two tabs 13 extending from the connecting portion 11. The connecting portion 11 defines four evenly spaced through holes 12 and two positioning holes 14 extending parallel with the optical axis OO′. The tabs 13 respectively define a number of through holes 1 6 extending parallel to the optical axis OO′ for securing the lens holder 10 to the projector (not shown).

The fixed barrel 20 is arranged to be secured to the holder 10. The fixed barrel 20 defines a number of threaded holes 22 on an end surface 21 thereof corresponding to the through holes 12. The fixed barrel 20 has two positioning pins 24 extending from the end surface 21 for engaging with the positioning holes 1 4 of the holder 10. The fixed barrel 20 includes a sidewall 23 which defines a number of linear guide slots 28 therein. The linear guide slots 28 are oriented in parallel with the optical axis OO′. In the present embodiment, the fixed barrel 20 has three linear guide slots 28 evenly formed in the sidewall 23 at 120° intervals with respect to the axis OO′. The fixed barrel 20 includes three protruding posts 26 extending from the sidewall 23 and the three protruding posts 26 are evenly spaced at 120° intervals with respect to the axis OO′. Preferably, the three protruding posts 26 and the positioning pins 24 are integrally formed with the fixed barrel 20. The three protruding posts 26 and the positioning pins 24 can be formed on the fixed barrel 20 by injection molding or press-molding and so on.

The rotatable barrel 30 receives the fixed barrel 20. In the present embodiment, the rotatable barrel 30 includes a circumferential wall 31 which defines two groups of cam grooves 32. A latching groove 36 is circumferentially defined in an inner surface of the circumferential wall 31 adjacent to an edge thereof. Three insertion cutouts 34 are defined in the edge of the rotatable barrel 30 communicating with the latching groove 36. Each group of the cam grooves 32 has three cam grooves 32 evenly spaced and defined in the circumferential wall 31 at 120° intervals with respect to the axis OO′. The latching groove 36 is configured for receiving the protruding post 26 of the fixed barrel 20 therein via the guiding of the insertion cutouts 34.

Each of the fasteners 40 is engaged in a corresponding set of the holes 22, 12 for securing the fixed barrel 20 to the holder 10.

The at least one lens group 60 is received in the fixed barrel 20. In the present embodiment, the fixed barrel 20 receives two lens groups 60 therein.

In the present embodiment, the lens module 200 has two groups of cam followers 50 for engaging with the cam grooves 32. Every cam follower 50 engaging with a cam groove 32 is configured for securing to a lens group 60 through a corresponding one of the linear guide slots 28.

In the lens module 200, the lens groups 60 can only be moved along the direction of the optical axis OO′ without rotating about the optical axis OO′ and the rotatable barrel 30 is immovable in the direction of the optical axis OO′ and is rotatable about the optical axis OO′. By rotating the rotatable barrel 30, the lens groups 60 can be driven by the cam followers 50, and accordingly the focal length of the lens system is adjustable.

In the present embodiment, the holder 10 can be formed by injection molding, press-molding, or punching and so on without using lathes. So, the holder 10 can be made easier and faster, accordingly, the cost of the lens module 200 is reduced.

While certain embodiments have been described and exemplified above, various other embodiments will be apparent to those skilled in the art from the foregoing disclosure. The present invention is not limited to the particular embodiments described and exemplified, and the embodiments are capable of considerable variation and modification without departure from the scope of the appended claims.

What is claimed is:

1. A lens module comprising:
at least one lens group;
a fixed barrel receiving the at least one lens group, the fixed barrel defining in an end surface thereof a plurality of fastener holes oriented parallel with an optical axis of the at least one lens group;
a rotatable barrel receiving the fixed barrel therein, the rotatable barrel being rotatable relative to the fixed barrel about the optical axis;
a holder defining a plurality of through holes parallel with the optical axis corresponding to the fastener holes of the fixed barrel; and
a plurality of fasteners configured for securing the fixed barrel to the holder via the through holes and being received in the fastener holes.

2. The lens module as claimed in claim 1, wherein the holder defines a plurality of positioning holes and the fixed barrel has positioning pins extending from the end surface for engaging with the positioning holes of the holder.

3. The lens module as claimed in claim 1, wherein the fixed barrel has a plurality of linear guide slots formed in a sidewall thereof for guiding the lens group to move along the optical axis.

4. The lens module as claimed in claim 3, wherein the fixed barrel has three linear guide slots formed evenly spaced at 120° intervals with respect to the optical axis.

5. The lens module as claimed in claim 1, wherein the rotatable barrel has a plurality of cam grooves and the lens barrel further comprises a plurality of cam followers secured to the lens group for moveably engaging with the cam grooves.

6. The lens module as claimed in claim 5, wherein each lens group has three cam followers secured thereon at 120° intervals with respect to the optical axis.

7. The lens module as claimed in claim 1, wherein the fixed barrel has a sidewall from which a plurality of protruding posts extend and the rotatable barrel has an inner latching groove circumferentially defined in an inner surface thereof and a plurality of insertion cutouts defined in an edge of the rotatable barrel communicating with the inner latching groove, the protruding posts being insertable in the insertion cutouts and engaged in the latching groove for preventing the rotatable barrel from moving axially relative to the fixed barrel.

8. The lens module as claimed in claim 7, wherein the protruding posts are integrally formed with the fixed barrel.

9. The lens module as claimed in claim 2, wherein the positioning pins are integrally formed with the fixed barrel.
